(19) United States
(12) Patent Application Publication
(10) Pub. No.: US 2015/0072572 A1
(43) Pub. Date: Mar. 12, 2015

(54) Locking Electrical Connector

(71) Applicant: James Frank Easterling, Albuquerque, NM (US)

(72) Inventor: James Frank Easterling, Albuquerque, NM (US)

(21) Appl. No.: 14/023,620

(22) Filed: Sep. 11, 2013

(51) Int. Cl. H01R 11/24; B25B 7/22; B25B 7/12

(52) U.S. Cl. CPC H01R 11/24; B25B 7/123; B25B 7/22
USPC 439/863; 81/367

(57) ABSTRACT

Disclosed is a locking electrical circuit apparatus connection device capable of making a firm electrical connection where more certainty is a premium. The locking electrical connector creates electrical connections of temporary and semi-permanent nature improving the quality of connections than was heretofore possible, drastically reducing the prospect of unintentional disconnection, reducing health and safety hazards, making a new and useful improvement over electrical connectors of this kind in the past.

### BACKGROUND OF THE INVENTION

1. Field of the Invention

The present invention is directed to an electrical circuit apparatus device with method of means and function to make a firm connection, the primary use for jumping power or signal from one source to another as in one battery to another, or as in connecting a ground.

2. Description of the Prior Art

The need for jumping electricity or signal from one component or point to another is encountered very often as in charging a battery. The conventional methods for jumping or charging have been the use of an alligator clip or interlocking push connector, typically with two halves of housing to make the connection. Often these conventional connections can be tenuous, uncertain and almost dangerous or semi-permanent with a limited range of applications. While operating the alligator clip one may be unable to keep them open easily or find them too easy to open leaving a loose connection, one may find a small space to which the alligator clip is hard to attach or one may find the gripping jaws an inefficient design to make a sound attachment. The push connector has limited range of applications.

U.S. Pat. No. 4,815,991 Describes a device for making electrical connection in which the device can serve either as a clip or a plug. The device includes a pair of pivotally interconnected jaws which can open and be clipped onto a wire or electrical terminal, the jaws being biased toward each other. In one embodiment, each jaw is provided near its outer surface with an electrically conductive member defined by one or more resilient electrical contact elements which extend longitudinally of the corresponding jaw. The elements of each member are integral with a pair of semi-circular bands which are secured in any suitable manner, such as by soldering or spot welding, to the outer surface of the respective jaw. When the jaws are closed, the members mate with each other at the side edges to form a banana plug which can be inserted into a jack or other tubular recess. In another embodiment, the jaws have integral contact elements thereon which define a banana plug configuration when the jaws are closed. The connector is provided with a tubular extension on one of the jaws thereof for use as a jack to receive the plug formed by the jaws and members of a second, substantially identical connector or a conventional banana plug whereby two or more connectors can be ganged for electrical interconnection.

This design is restricted by the limited configuration of the alligator clip. The nose of the clip is unable to grasp many spaces with surety. The deficient alignment of the jaw can make it difficult for grasping a variety of mark objects. It can be dislodged under rough conditions. It does anticipate a bias to opening and does not lock on the mark object.

U.S. Pat. No. 6,871,387 describes a device for making an electrical connection as an alligator clip with an improved structure including a first and a second clip members connected to each other by a pivot pin is disclosed. A resilient member is installed on the pivot pin with two opposite ends in contact against the interior surfaces of the first and second members. The front ends of the first and second clip members are used to clip the positive/negative electrode of the car battery. A securing member formed from the bottom end of the first clip member, including a through hole each on two opposite ends to wrap a power cord so that two through holes are aligned to receive a fixture to secure the securing member on the power cord.

This design is restricted by the limited configuration of the alligator clip. The nose of the clip is unable to grasp many spaces with surety. The deficient alignment of the jaw can make it difficult for grasping a variety of mark objects. It can be displaced under rough conditions. It does not anticipate a bias to opening and does not lock on the mark object.

U.S. Pat. No. 5,002,508 Is an electrical connecting device that is a battery cable connector disclosed for connecting to batteries that have a side terminal, as well as for batteries that have a top terminal. The invention provides for connection to either type of batteries without any further modification of the battery cable connector. Two sets of openings within the conductive portion of the battery connector cable enable easy attachment to either a side mounted battery terminal or a top mounted battery terminal without further reconfiguration of the battery cable connector.

While anticipating the need for grasping a commonly different mark object, said patent needs a twist for different applications, increasing likelihood of dislodging. This design is restricted by the limited configuration of attachment. The nose of the clip is unable to grasp many spaces with surety. The deficient alignment of the jaw makes it difficult for grasping a variety of mark objects. It can be dislodged under rough conditions. It does not anticipate a bias to opening and does not lock on the mark object.

U.S. Pat. D526,560 is an ornamental design for an alligator clip representing and addressing the virtual standardization of the alligator clip. The alligator clip is a plateau of quality and/or achievement, itself a device as a measure in order to make comparisons. In many embodiments it is a standard tool.

The design is restricted by the limited configuration of the alligator clip. The nose of the clip is unable to grasp many spaces with surety. The deficient schema and alignment of the jaw can make it difficult for grasping a variety of mark objects. It can be displaced under rough conditions. It does not anticipate a bias to opening and does not lock on the mark object.

U.S. Pat. No. 8,302,512 is a locking pliers including a slide bar mounted in both second handle unit and locking unit and comprising a wavy edge facing bottom of the second handle unit, the wavy edge including a rear slot member and a forward hook; and a movable jaw at a forward end of the second handle nit [sic] and comprising two intermediate opposite stop members each having an inclined edge, a channel between the stop members with a forward end of the slide bar movably received therein, and a rear stop bar interconnected two sidewalls of a rear portion of the movable jaw, the inclined edges being stopped by bending members on sidewalls of the second handle unit for retaining the stop members in an inoperative position.

This patent does not anticipate many elements including: non-conducting parts; electrical conducting parts, as in jaws or sleeves on jaws making point of electrical contact to a mark object; an electrical line running longitudinally of a handle; an electrical line interior of a handle of the jaw lever; an electrical line exterior of a handle of the jaw lever; a sleeve to retain an electrical line exterior or interior of a handle; a connection of an electrical cable to conducting jaws; a fixed link or crossbar between the two jaws; an electrical connector at the base of a handle; a modification of a primary handle allowing line bypass of spring; an in-line fuse, or electrical connection indicator or a quick-connect-release device, as in a banana plug.

U.S. Pat. D653,092 is an ornamental design for a locking pliers assembly, representing and addressing the virtual standardization of locking pliers. The locking pliers are a plateau of quality and/or achievement, the device a measure in order to make comparisons. In typical embodiment it is a standard tool.

This patent does not anticipate many elements including: non-conducting parts; electrical conducting parts; as in jaws or sleeves on jaws making a point of electrical contact to a mark object; an electrical line running longitudinally of a handle; an electrical line interior of a handle of the jaw lever; an electrical line exterior of a handle of the jaw lever; a sleeve to retain an electrical line exterior or interior of a handle; a connection of an electrical line to conducting jaws; a fixed link or crossbar between the two jaws; an electrical connector at the base of a handle; a modification of the primary handle allowing line bypass of spring; an in-line fuse, or electrical connection indicator, or quick-connect-release device, as in a banana plug.

U.S. Pat. No. 8,500,478 is an electrical connector comprises includes [sic] an insulative [sic] housing having a receiving space, a plurality of terminals retained in the insulative housing, a metal retaining portion assembled on the insulative housing. The insulative housing comprises includes a pair of block portions extending toward opposite direction directions with each other; and each of the blocking portions has a resisting face. The metal retaining metal includes a reinforced portion arranged behind the blocking portion and attached to the resisting face of the blocking portion. Therefore, it can prevent the blocking portion of the housing from breaking off during an unexpected situation.

This patent is limited to housing configurations, limiting range of applications. This patent shows a bias to lock closed, instead of a bias to open. The electrical connection needs matching parts and cannot be used one-handed. This patent does not anticipate many elements including: a conducting jaw apparatus; an electrical line running longitudinally of a handle; an electrical line interior of a handle jaw lever; an electrical line exterior of handle; a sleeve/hilt/grip containing parts; a connection of an electrical line to a conducting jaw apparatus; a fixed link or crossbar between jaws; an electrical connector housing with or without a quick-connect-release device, in-line-fuse or electrical connection indicator; or a modification of a handle allowing line bypass of spring device.

U.S. Pat. No. 7,841,885 B2 is a connector [that] has snap-fit lock including a partially deformable locking member which is mounted on the housing so as to be axially slideable between an extended locking position and a retracted position; and a biasing spring which axially bias said locking member to its locking position. The locking member has a flexible beam including a tooth member adapted to engage a complementary locking projection of the counterpart connector, and to provide an axial stop therewith. The flexible beam is elastically deflectable on the axial path of the locking member, whereby the snap-fit effect is provided by elastic load, both axial and in flexion, of the flexible beam.

This patent is limited to housing configurations, limiting range of applications. This patent shows a bias to lock closed, instead of a bias to open. The electrical connection needs matching parts and cannot be used one-handed. This patent does not anticipate many elements including: a conducting jaw apparatus; an electrical line running longitudinally of a handle; an electrical line interior of a handle jaw lever; an electrical line exterior of handle; a sleeve/hilt/grip containing parts; a connection of an electrical line to a conducting jaw apparatus; a fixed link or crossbar between jaws; an electrical connector housing with or without a quick-connect-release device, in-line-fuse or electrical connection indicator; or a modification of a handle allowing line bypass of spring device.

### SUMMARY OF THE INVENTION

The present invention is a locking electrical circuit apparatus device with method of means and function to make a more firm electrical connection, overcoming the deficiencies of previous devices. The device includes a pair of pivotally interconnected jaws which can open, align and clip, or lock onto wire or electrical terminal, or variety of objects. In one embodiment one or each of two jaws is made of or coated by electrically conducive material, with one or more resilient electrical contact elements extending longitudinally of the corresponding jaw.

It is therefore the primary object of the invention to provide a locking pliers conducting electricity comprising a hollow primary handle unit; a stationary jaw apparatus of conducting materials; a connection from a conducting jaw to conducting line; said conducting line running inside or outside and the length of a handle; a hollow second handle/jaw unit of non-conducting resilient materials, pivotally secured and movable relative to the first jaw between an open position and a closed, locked position.

It is another object of the present invention to provide electrical locking pliers which will significantly enhance the convenience of making a firm connection at a significant savings.

It is still another object of the present invention to provide a locking electrical connector which can be adapted to use in various connections, wires, terminals and mark objects.

It is still another object of the present invention to provide a firm connection on a terminal or post or other mark object that is more difficult for apparatus previously presented, or where use of one hand is preferred.

It is still another object of the present invention to provide a firm connection with one hand of the user in reaching limited access or where there may be limited clearance.

It is yet another object of the present invention to provide spring tension biased to release a lock (open) instead of biased to grasping (closed) tension.

It is still another object of the present invention to provide electrical locking pliers which improve the safety of the user.

It is yet another object of the present invention to provide a locking electrical connector that can make a cheaper, higher quality, more safe and quick electrical connection.

These and other objects of the present invention will become apparent to those skilled in the art upon reading the accompanying description, drawings, and claims set forth herein. The headings provided herein are for the convenience of the reader only. No headings shall be construed to be limiting upon the content in any way.

### BRIEF DESCRIPTION OF THE DRAWINGS

FIG. 1 is a side sectional view of the locking electrical connector, in one embodiment in which the device is open, the connecting line is exterior of jaw handle main body, but enclosed in covering hilt/sleeve/grip, and the jaw opening is adjustable according to the present invention.

FIG. 2 is a side sectional view of the locking electrical connector, in one embodiment in which the device is in closed or locking position, the connecting line is interior of jaw handle main body and the jaw opening is not adjustable, excepting by pre-determined configuration, and enclosed in covering sleeve/hilt/grip, according to the present invention.

### DETAILED DESCRIPTION OF THE INVENTION

### 1. Definitions

Line as used herein shall mean a conduit, channel, passage, transmission or course of electricity or signal usually of a conducting material encapsulated by non-conducting material, as in an electrical wire, power cord or cable.

Mark object as used herein shall mean a line, wire, electrical terminal, component or any object meant to be grasped by the present invention.

Jumping as used herein shall mean to transmit, send, convey or forward electricity or signal from one location to another as in using jumper cables.

### 2. Best Mode of the Invention

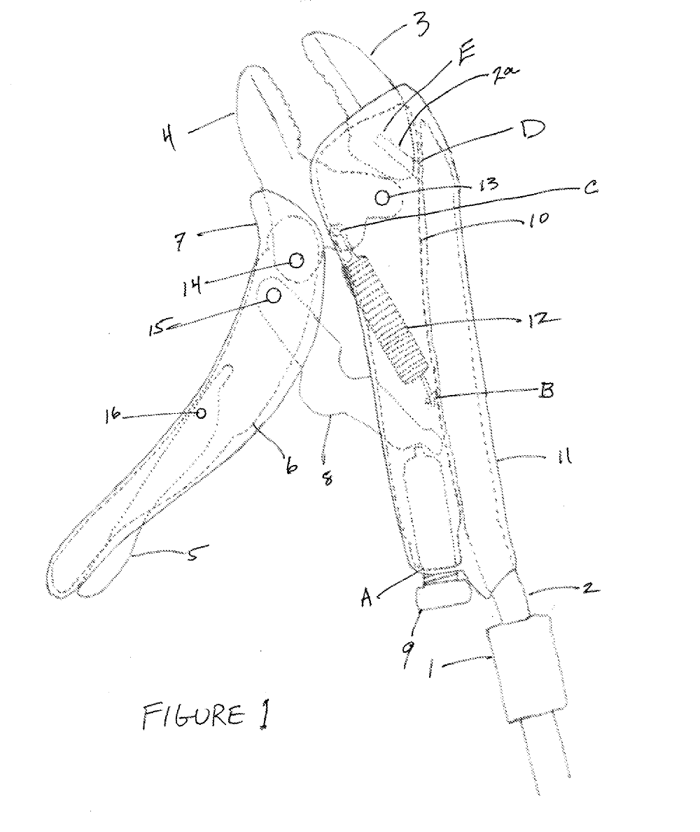

FIG. 1 shows a side sectional view of the best mode contemplated by the inventor of the locking electrical connector with an adjustable embodiment according to the concepts of the present invention. The line may be anchored in a terminal or may be joined to another apparatus device to complete a connection.

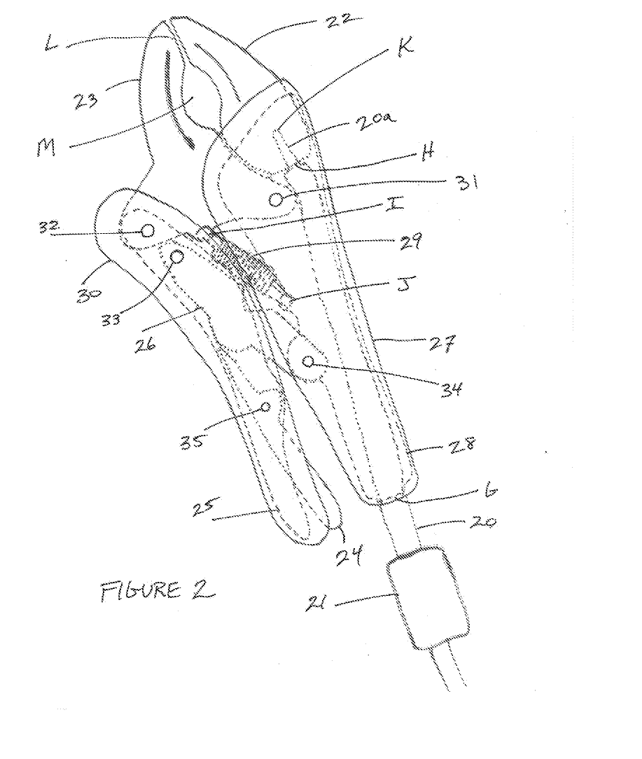

FIG. 2 shows a side sectional view of the best mode contemplated by the inventor of the locking electrical connector with a non-adjustable embodiment, where the range of application is mostly defined by the configuration of the opposing jaws. The line may be anchored in a terminal or may be joined to another apparatus device to complete a connection.

### 3. How to Make the Invention.

The current invention comprises a pair of hinged and pivotal handles connected providing jaws at one end the means for movement toward and away from each other with open and closed position; spring means tending to urge jaws apart; a locking mechanism for jaws in the closed position; a release mechanism; one or both jaws of conducting materials and means of connection; the jaws separable permitting an electrical component or mark object be inserted; a line running longitudinally interior or exterior of a handle; a housing for an in-line electrical connection indicator and/or fuse, and/or quick-connect-release device.

As can be seen from FIG. 1 and FIG. 2 the locking electrical connector comprises a hollow first handle 10 (or FIG. 2 part 28) of a resilient non-conducting material, fabricated in a U-shape to receive: snuggly a jaw apparatus 3 (2:22) of conducting material; the interior end of a triangular pivoting jaw 4 (23) of resilient non-conducting material itself secured to 10 by a rivet 13 (31); a spring 12 (29) secured to 4 by a hook through a hole at location C and secured to 10 by a hook to perforation at location B, or as in FIG. 2 secured to 23 by a hook through a hole at location I and secured to 28 by a hook and hole at location J; a crossbar 8 (26) of a resilient non-conducting material which fits through the U-slot of each handle not secured to 10 but is movable interior of 10, or as in FIG. 2 secured by rivet 34 to 28; an adjustable screw 9, of a resilient non-conducting material, fitted to circular opening at location A which itself modifies, interior space of 10, position of and secures 8, and is screwed in after sleeve/hilt/grip 11 of a non-conducting insulating semi-pliable molded material is slid over entire 10 assembly, or as in FIG. 2 no adjusting screw exists, whereby hilt/sleeve/grip 27 slides over entire 28 assembly. Additionally 10 and 3 have a shared hole drilled or pre-fabricated at location D, while 22 has hole drilled or pre-fabricated at location H. A line 2 is cut on a bias with interior conducting line 2a stripped, exposed and turned to fit into drilled or pre-fabricated hole at location D, or as in FIG. 2 the line 20 passes interior of 28 at location G terminating with stripped, exposed conducting line 20a to fit into drilled or pre-fabricated hole at location H. Part 3 (22) is secured to 10 (28 respectively), by a crimp/punch at location E (K) simultaneously securing 2a (20a) interior of 3 (22 respectively) and creating an electrical circuit connection.

As can be seen from FIG. 1 and FIG. 2 the locking electrical connector comprises a hollow second handle 6 (or 2:25) of a resilient non-conducting material with U-shape to receive: opposing, triangular pivot jaw 4 (23) of resilient non-conductive material itself secured by rivet 14 (32); 8 (26) secured by rivet 15 (36); release lever 5 (24) of a non-conducting resilient material and conforming semi-U-shape, secured by rivet 16 (35); and sleeve/hilt/grip 7 (30) of a non-conducting semi-pliable material on its exterior.

As can be seen from FIG. 1 and FIG. 2 the locking electrical connector comprises of housing 1 (21) for an in-line fuse, and/or connection quality indicator, and/or quick-connect-release device which if flush to 11 (27) acts also as collar and securing apparatus.

As can be seen from FIG. 1 and FIG. 2 the locking electrical connector comprises of jaws 3&4 and 22&23 capable of many configurations and design for ranges of application. When closed, present invention may lock on mark object of small diameter at location L, and with same configuration as shown, lock on mark object of much larger diameter at location M. Jaws 3&4 and 22&23 may be shaped in other manner, as in a needle-nose configuration and/or variations of serrated edges.

### 4. How to Use the Invention

The problems addressed by the locking electrical connector are many, as can be easily seen by those skilled in the art. The present invention in one embodiment opens as illustrated in FIG. 1 with the jaw diameter adjustable by turning/screwing 9 clockwise or counter-clockwise to lessen or increase jaw diameter respectively. User encircles mark object with jaws 3 and 4 (22 & 23 in FIG. 2) and clamps down, locks, initiates electrical contact and firm grip by squeezing handles or exerting torque of one handle toward the other. From a locking position as illustrated in FIG. 2 user pushes 24 at bottom toward interior of 25, or as in FIG. 1 pushes 5 at bottom toward interior of 6, exerting pressure on 26 (1:8) at opposite end of 24 (5) to release present invention from its firm grip and electrical circuit connection to mark object.

### 5. Examples of the Invention

Thus it will be appreciated by those skilled in the art that the present invention is not restricted to the particular preferred embodiments described with reference to the drawings, such detail to be understood in an instructive rather than any restrictive sense, and that variations may be made therein without departing from the scope of the present invention as defined in the appended claims and equivalents thereof.

What is claimed is:

1. A locking electrical connector, comprising:
A pair of hinged and pivotal handles connected providing jaws at one end the means for movement toward and away from each other with open and closed position; spring means tending to urge jaws apart; a locking mechanism for jaws in the closed position;
a release mechanism; one or both jaws of conducting materials and means of connection; the jaws separable permitting an electrical component or mark object be inserted; a line running longitudinally interior or exterior of a handle; a housing for an in-line electrical connection indicator and/or fuse, and/or quick-connect-release device; a hollow primary handle of a resilient non-conducting material, fabricated in a U-shape receives a jaw apparatus of conducting material, and the interior end of a triangular pivoting jaw of resilient non-conducting material itself secured by a rivet; a spring secured to the opposing non-conducting pivot jaw by a hook through a hole and secured to a primary handle by a hook to perforation, or secured to pivot jaw by a hook through a hole and secured to primary handle by a hook and hole; a crossbar of a resilient non-conducting material which fits through the U-slot of each handle secured by rivet to secondary handle but does not secure to a primary handle, but is movable interior of it, or secured by rivet to a primary handle; an adjustable screw, of a resilient non-conducting material, fitted to circular opening at bottom or opposite end from jaws of a primary handle, which itself modifies interior space of a primary handle, positioning and securing crossbar, and is inserted or screwed in; after sleeve/hilt/grip of a non-conducting, insulating semi-pliable material is slid over entire primary handle assembly;
the primary handle and conducting jaw apparatus having a shared drilled or pre-fabricated hole, or in one non-adjustable embodiment hole drilled or pre-fabricated in conducting jaw apparatus alone; a line is cut on a bias at its end with interior conducting line stripped, exposed and turned to fit into drilled or pre-fabricated hole, passing through exterior to interior of primary handle, or in one embodiment the line passes interior of primary handle terminating with stripped, exposed conducting line fit into drilled or pre-fabricated hole; conducting jaw apparatus is secured also to primary handle by a crimp/punch simultaneously securing line tip interior of conducting jaw apparatus making an electrical circuit connection; a hollow secondary handle of a resilient non-conducting material with U-shape receives opposing triangular pivot jaw of resilient non-conductive material itself secured by rivet, and crossbar secured by rivet, and release lever of a non-conducting resilient material and conforming semi-U-shape secured by rivet; a sleeve/hilt/grip of a non-conducting semi-pliable insulating material exterior of secondary handle; a housing exterior of primary handle housing assembly for an in-line fuse, and/or connection quality indicator, and/or quick-connect-release device, as in a banana plug; which housing if flush to primary handle housing assembly acts also as collar securing device; opposing jaws capable of many configurations and design for ranges of application; when closed present invention may lock, making electrical circuit, on mark object of odd-shape or small diameter, or lock on mark object of much larger diameter.

2. An electrical circuit apparatus locking pliers device according to claim 1 with parts composition of matter comprising of: non-conducting and/or insulated material.

3. An electrical circuit apparatus connecting locking pliers device according to claim 1 with method of means and function wherein a multitude of jaw configurations enable a multitude of applications, as in serrated or non-serrated, and/or semi-circular, and/or needle-nose configurations.

4. An electrical circuit apparatus locking pliers device according to claim 1 with a method of means and function to enclose primary handle and/or secondary handle and line with a sleeve/hilt/grip.

5. A device apparatus according to claim 4 composition of matter comprising of: non-conducting, insulating semi-pliable material.

6. A locking pliers with an electrical circuit jaw apparatus, composition of matter comprising: an electrically conducting material.

7. An electrical circuit jaw apparatus according to claim 6 with a method of means and function to snuggly insert to a handle.

8. An electrical circuit jaw apparatus according to claim 7 with a method of means and function wherein said jaw and a handle are joined by a means for fastening.

9. An electrical circuit jaw apparatus according to claim 8 with a method of means and function wherein said jaw and a handle are joined by means for fastening is a fastener selected from the group consisting of: rivet, nut & bolt, pop rivet, spot weld, fusion bonding, adhesive bonding, weldment, crimp, stamp, or line inserted into a hole.

10. An electrical circuit jaw apparatus according to claim 9 with a method of means and function wherein said jaw and a primary handle are joined by means for fastening is a fastener wherein a line is inserted to a drilled or pre-fabricated hole.

11. An electrical circuit apparatus connecting device according to claim 10 with a method of means and function wherein said jaw and a primary handle are joined by means for fastening is a fastener wherein a line is inserted to a drilled or pre-fabricated hole and is secured with a stamp/crimp.

12. An electrical circuit connecting locking pliers with a method of means and function wherein a line runs longitudinally of a handle.

13. An electrical circuit apparatus connecting device according to claim 12 with a method of means and function wherein the line passes exterior of the primary handle sleeve/hilt grip assembly and a housing contains in-line circuit indicator and/or fuse and/or quick-connect-release device.

14. An electrical circuit apparatus connecting device according to claim 13 with a method of means and function wherein the housing for the in-line circuit indicator and/or fuse and/or quick-connect-release device acts as a securing apparatus for the sleeve/hilt/grip, a housing itself for handle and line.

15. An electrical circuit apparatus connecting device according to claim 12 with a method of means and function wherein a line connects to a conducting jaw apparatus.

16. An electrical circuit apparatus connecting device according to claim 15 with a method of means and function wherein a line connects to a conducting jaw apparatus is a fastener selected from the group consisting of: rivet, nut & bolt, pop rivet, spot weld, fusion bonding, adhesive bonding, weldment, crimp, stamp, or line inserted into a hole.

17. An electrical circuit apparatus connecting device according to claim 16 with a method of means and function wherein a line runs longitudinally on the exterior of a primary handle.

18. An electrical circuit apparatus connecting device according to claim 16 with a method of means and function wherein a line runs longitudinally on the interior of a primary handle.

19. An electrical circuit apparatus connecting device according to claim 18 with a method of means and function wherein a primary handle is modified for a spring attachment point interior or more central, allowing space for passage of a line interior of said handle.

20. An electrical circuit apparatus connecting device according to claim 18 with a method of means and function wherein a primary handle is modified for a crossbar attachment point interior or more central, allowing space for passage of a line interior of said handle.
